(19) United States
(12) Patent Application Publication
(10) Pub. No.: US 2025/0014289 A1
(43) Pub. Date: Jan. 9, 2025

(54) VIRTUAL REALITY CLINICAL IMMERSION

(71) Applicant: Virginia Tech Intellectual Properties, Inc., Blacksburg, VA (US)

(72) Inventors: Jennifer S. Wayne, Blacksburg, VA (US); Cameron Moore, Blacksburg, VA (US); Wallace Santos Lages, Blacksburg, VA (US)

(21) Appl. No.: 18/763,083

(22) Filed: Jul. 3, 2024

Related U.S. Application Data
(60) Provisional application No. 63/512,086, filed on Jul. 6, 2023.

(51) Int. Cl. G06T 19/00; G09B 5/06

(52) U.S. Cl. CPC G06T 19/006; G09B 5/06

(57) ABSTRACT

Disclosed herein are methods and systems for creating educational virtual reality environments. One or more cameras may capture 360-degree images of a medical environment. Each of the 360-degree images are captured with a camera being placed at a respective location. A computing device may create a virtual reality environment of the medical environment based on the 360-degree images, by, for each of the 360-degree images, placing a user viewpoint at the respective location of the respective camera that captured the respective 360-degree image, placing a graphical representation of a first class at each other respective location that is visible in the respective 360-degree image, and placing a graphical representation of a second class over each object visible in the respective 360-degree image that has particular educational content assigned to the object. The computing device may output, for interactive display at a virtual reality device, the virtual reality environment.

### CROSS-REFERENCE TO RELATED APPLICATION(S)

This application claims the benefit under 35 U.S.C. § 119(e) to U.S. Provisional Application 63/512,086, filed Jul. 6, 2023, and entitled “VIRTUAL REALITY CLINICAL IMMERSION”, which is hereby incorporated herein by reference in its entirety.

### FIELD

The various examples herein relate to training material and techniques for medical environments.

### BACKGROUND

In educating trainees to medical environments, there are limited opportunities for in-person experiences. In training for specific situations, a patient must be experiencing a certain set of symptoms, have certain diagnoses, and/or undergoing certain procedures in order for trainees and professionals to get adequate exposure for those situations. Certain locales within a hospital or clinical setting may also not be consistently available, limiting the time that trainees can tour those spaces, learn about the various equipment in that locale, and experience in-person the activities of those locales.

### BRIEF SUMMARY

Discussed herein are various examples of creating virtual reality environments for the purpose of educational training. These virtual reality environments are created from real-life physical spaces and with living participants, versus computationally simulated environments and participants, to permit the user to experience as much as possible the actual activity in three-dimensions. In one example method, one or more cameras capture one or more 360-degree photographs of a medical environment, wherein each of the one or more 360-degree photographs are captured with one or more cameras being placed at a respective location. For the purposes of this disclosure, it is to be recognized that one or more 360-degree photographs may be static images. Additionally, a plurality of 360-degree photographs captured in quick succession may cause each of the 360-degree photographs to be equivalent to a frame in a 360-degree video, such that, when the plurality of 360-degree photographs are cycled through in quick succession, a 360-degree video is played, potentially with accompanying audio. In other words, the images captured using the techniques of this disclosure may be static images or videos, with or without audio, and the use of “images” or “photographs” throughout this disclosure include both static images and moving videos. The method further includes creating, by one or more processors, a virtual reality environment of the operating room environment based on the one or more 360-degree photographs of the medical environment, wherein creating the virtual reality environment comprises, for each of the one or more 360-degree photographs, (i) placing a user viewpoint at the respective location of the respective camera of the one or more cameras that captured the respective 360-degree photograph, (ii) placing a first class of graphical representation at each other respective location that is visible in the respective 360-degree photograph, and (iii) placing a second class of graphical representation over each object visible in the respective 360-degree photograph that has particular educational content assigned to the object. The method further includes outputting, by the one or more processors and for interactive display at a virtual reality device, the virtual reality environment.

In Example 1 of this disclosure, a method includes (a) capturing, by one or more cameras, one or more 360-degree images of a medical environment, wherein each of the one or more 360-degree images are captured with one of the one or more cameras being placed at a respective location; (b) creating, by one or more processors, a virtual reality environment of the medical environment based on the one or more 360-degree images of the medical environment, wherein creating the virtual reality environment comprises, for each of the one or more 360-degree images: (i) placing a user viewpoint at the respective location of the respective camera of the one or more cameras that captured the respective 360-degree image; (ii) placing a graphical representation of a first class at each other respective location that is visible in the respective 360-degree image; and (iii) placing a graphical representation of a second class over each object visible in the respective 360-degree image that has particular educational content assigned to the object; and (c) outputting, by the one or more processors and for interactive display at a virtual reality device, the virtual reality environment.

Example 2 of this disclosure relates to the method of Example 1, wherein the one or more 360-degree images comprises a plurality of 360-degree images.

Example 3 of this disclosure relates to the method of Example 2, further comprising: (a) while outputting the virtual reality environment, placing, by the one or more processors, a current viewpoint at the user viewpoint of a first 360-degree image of the plurality of 360-degree images.

Example 4 of this disclosure relates to the method of Example 3, further comprising: (a) receiving, by the one or more processors, an indication of user input selecting a graphical representation visible from the current viewpoint within the virtual reality environment, wherein the graphical representation belongs to the first class of graphical representation; and (b) in response to receiving the indication of user input: (i) updating, by the one or more processors, the current viewpoint to be the user viewpoint for a second 360-degree image of the plurality of 360-degree images; and (ii) outputting, by the one or more processors and for interactive display at the virtual reality device, the virtual reality environment as depicted from the user viewpoint for the second 360-degree image.

Example 5 of this disclosure relates to the method of any one or more of Examples 3-4, further comprising: (a) receiving, by the one or more processors, an indication of user input selecting a graphical representation visible from the current viewpoint within the virtual reality environment, wherein the graphical representation belongs to the second class of graphical representation; and (b) in response to receiving the indication of user input: (i) updating, by the one or more processors, the virtual reality environment to include at least a portion of the particular educational content assigned to the selected graphical representation; and (ii) outputting, by the one or more processors, the virtual reality environment with at least the portion of the particular educational content assigned to the selected graphical representation.

Example 6 of this disclosure relates to the method of any one or more of Examples 1-5, wherein the educational content comprises one or more of: (i) a video; (ii) an image; (iii) textual content; and (iv) audio.

Example 7 of this disclosure relates to the method of any one or more of Examples 1-6, wherein the first class of graphical representations are depicted as graphical discs.

Example 8 of this disclosure relates to the method of any one or more of Examples 1-7, wherein the second class of graphical representations are depicted as graphical starbursts.

Example 9 of this disclosure relates to the method of any one or more of Examples 1-8, wherein the medical environment is a room or space in a hospital, medical facility, or treatment facility.

Example 10 of this disclosure relates to the method of any one or more of Examples 1-9, wherein the medical environment comprises one or more of: (i) an operating room; (ii) an emergency room; (iii) a clinical room; (iv) a scrubbing room; (v) a treatment room; (vi) a nursing station; (vii) a trauma unit; and (vii) an endoscopy unit.

Example 11 of this disclosure of this disclosure relates to the method of any one or more of Examples 1-10, wherein each of the one or more 360-degree images comprise one or more of: (i) static images; and (ii) videos.

In Example 12 of this disclosure, a computing device comprising one or more processors is configured to: (a) control one or more cameras to one or more 360-degree images of a medical environment, wherein each of the one or more 360-degree images are captured with one of the one or more cameras being placed at a respective location; (b) create a virtual reality environment of the medical environment based on the one or more 360-degree images of the medical environment, wherein creating the virtual reality environment comprises, for each of the one or more 360-degree images: (i) place a user viewpoint at the respective location of the respective camera of the one or more cameras that captured the respective 360-degree image; (ii) place a graphical representation of a first class at each other respective location that is visible in the respective 360-degree image; and (iii) place a graphical representation of a second class over each object visible in the respective 360-degree image that has particular educational content assigned to the object; and (c) output, for interactive display at a virtual reality device, the virtual reality environment.

Example 13 of this disclosure relates to the computing device of Example 12, wherein the one or more 360-degree images comprises a plurality of 360-degree images.

Example 14 of this disclosure relates to the computing device of Example 13, wherein the one or more processors are further configured to: (a) while outputting the virtual reality environment, place a current viewpoint at the user viewpoint of a first 360-degree image of the plurality of 360-degree images.

Example 15 of this disclosure relates to the computing device of Example 14, wherein the one or more processors are further configured to: (a) receive an indication of user input selecting a graphical representation visible from the current viewpoint within the virtual reality environment, wherein the graphical representation belongs to the first class of graphical representation; and (b) in response to receiving the indication of user input: (i) update the current viewpoint to be the user viewpoint for a second 360-degree image of the plurality of 360-degree images; and (ii) output, for interactive display at the virtual reality device, the virtual reality environment as depicted from the user viewpoint for the second 360-degree image.

Example 16 of this disclosure relates to the computing device of Example 14, wherein the one or more processors are further configured to: (a) receive an indication of user input selecting a graphical representation visible from the current viewpoint within the virtual reality environment, wherein the graphical representation belongs to the second class of graphical representation; and (b) in response to receiving the indication of user input: (i) update the virtual reality environment to include at least a portion of the particular educational content assigned to the selected graphical representation; and (ii) output the virtual reality environment with at least the portion of the particular educational content assigned to the selected graphical representation.

In Example 17 of this disclosure, a non-transitory computer-readable storage medium has stored thereon instructions that, when executed, cause one or more processors of a computing device to: (a) control one or more cameras to one or more 360-degree images of a medical environment, wherein each of the one or more 360-degree images are captured with one of the one or more cameras being placed at a respective location; (b) create a virtual reality environment of the medical environment based on the one or more 360-degree images of the medical environment, wherein creating the virtual reality environment comprises, for each of the one or more 360-degree images: (i) place a user viewpoint at the respective location of the respective camera of the one or more cameras that captured the respective 360-degree image; (ii) place a graphical representation of a first class at each other respective location that is visible in the respective 360-degree image; and (iii) place a graphical representation of a second class over each object visible in the respective 360-degree image that has particular educational content assigned to the object; and (c) output, for interactive display at a virtual reality device, the virtual reality environment.

Example 18 of this disclosure relates to the non-transitory computer-readable storage medium of Example 17, wherein the one or more 360-degree images comprises a plurality of 360-degree images.

Example 19 of this disclosure relates to the non-transitory computer-readable storage medium of Example 18, wherein the instructions, when executed, further cause the one or more processors to: (a) while outputting the virtual reality environment, place a current viewpoint at the user viewpoint of a first 360-degree image of the plurality of 360-degree images.

Example 20 of this disclosure relates to the non-transitory computer-readable storage medium of Example 19, wherein the instructions, when executed, further cause the one or more processors to: (a) receive an indication of user input selecting a graphical representation visible from the current viewpoint within the virtual reality environment, wherein the graphical representation belongs to the second class of graphical representation; and (b) in response to receiving the indication of user input: (i) update the virtual reality environment to include at least a portion of the particular educational content assigned to the selected graphical representation; and (ii) output the virtual reality environment with at least the portion of the particular educational content assigned to the selected graphical representation.

While multiple examples are disclosed, still other examples will become apparent to those skilled in the art from the following detailed description, which shows and describes illustrative examples. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a virtual reality system in accordance with one or more techniques of this disclosure.

FIG. 2 is a block diagram illustrating a more detailed example of a computing device configured to perform the techniques described herein.

FIG. 3 is an example virtual reality environment, in accordance with the techniques of this disclosure.

FIG. 4 is an example virtual reality environment, in accordance with the techniques of this disclosure.

FIG. 5 is an example virtual reality environment, in accordance with the techniques of this disclosure.

FIG. 6 is an example virtual reality environment as a video, in accordance with the techniques of this disclosure.

FIG. 7 is a flow diagram illustrating an example method for creating a virtual reality environment, in accordance with the techniques of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

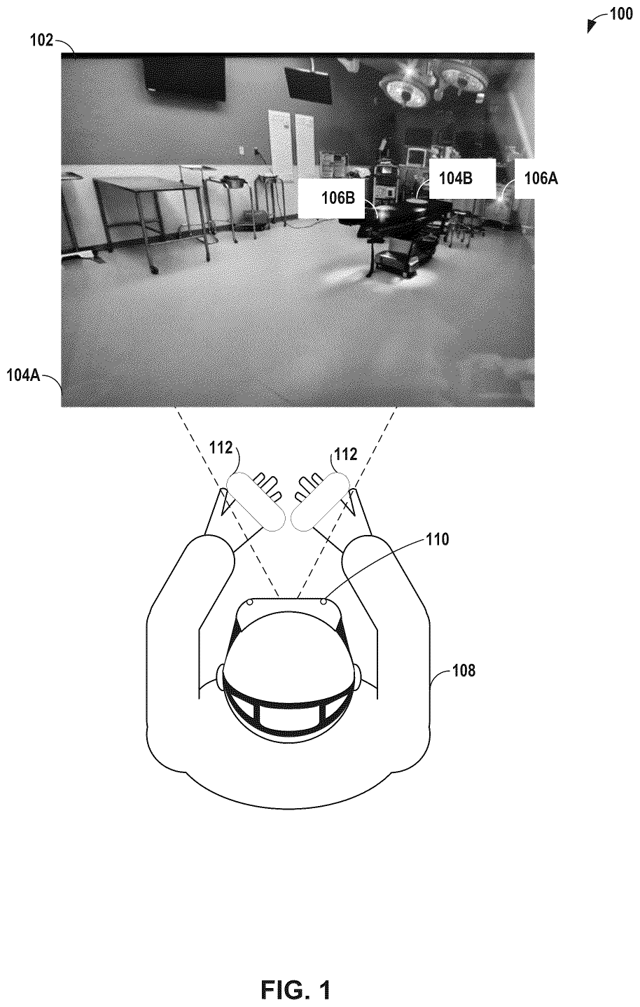

FIG. 1 is a conceptual diagram illustrating a virtual reality system 100 in accordance with one or more techniques of this disclosure. Virtual reality system 100 may include computing device 110. In some instances, user 108 can operate computing device 110 using one or more external controllers 112. Computing device 110 may be capable of producing and/or outputting virtual reality environment 102, which includes first class graphical representations 104A and 104B and second class graphical representations 106A and 106B. Virtual reality environment 102 may be a representation of an operating room as captured by one or more cameras in one or more 360-degree images, either static or video.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. For instance, computing device 110 may be a VR system itself. In other instances, computing device 110 is a separate computing device that outputs a virtual reality environment to a virtual reality display.

Virtual reality environment 102 may include an entry to a medical environment of an operating room that learners visualize in 3D. Pink disks (e.g., graphical representations 104A and 104B) may be “teleport” pads to which learners can change position, and vantage point, within the OR. The “starburst” (e.g., graphical representations 106A and 106B) on equipment permits expansion of a pop-up window with enlarged photo and description of the equipment.

Many in-person experiences can be replaced by Virtual Reality (VR) experiences. The Virtual Reality Clinical Immersion Projects capture the real-life 3D physical environment of any type of medical environment in which to present different clinical or other medical-related experiences, such as, but not limited to, the operating theater, surgical procedures, clinical examinations, and hospital stations. Alternatively, the medical environment can be any known physical environment, including any room or space, in which any type of clinical or medical-related experience may occur. These give learners the feeling of being physically present in the space.

The need for immersion to clinical environments by learners of all types is increasing and putting an unsustainable burden on facilities to accommodate in-person experiences. These learners may be undergraduate students, medical students, nursing trainees, etc. Many of the in-person experiences can be replaced by Virtual Reality (VR) experiences. The Virtual Reality Clinical Immersion Projects captures the real-life 3D physical environment (images and/or video) in which different clinical environments are presented, such as the operating theater, surgical procedures, clinical examinations, and hospital stations. Learners are able to teleport to different vantage points to visualize the environment from different perspectives.

The advantages of the VR techniques described herein are several-fold. The experiences provided are scalable as they can be used with or without the presence of an instructor. Additionally, there are numerous environments that can be presented. Our VR projects provide flexibility as the projects can be available in VR and on screen, making the VR projects accessible to all learners. They are cost-effective as the projects immerse learners in the preparatory experiences and better prepare them for the clinical environment, thus reserving the in-person exposure to critical experiences as needed. Further, the experiences can be viewed by an unlimited number of users.

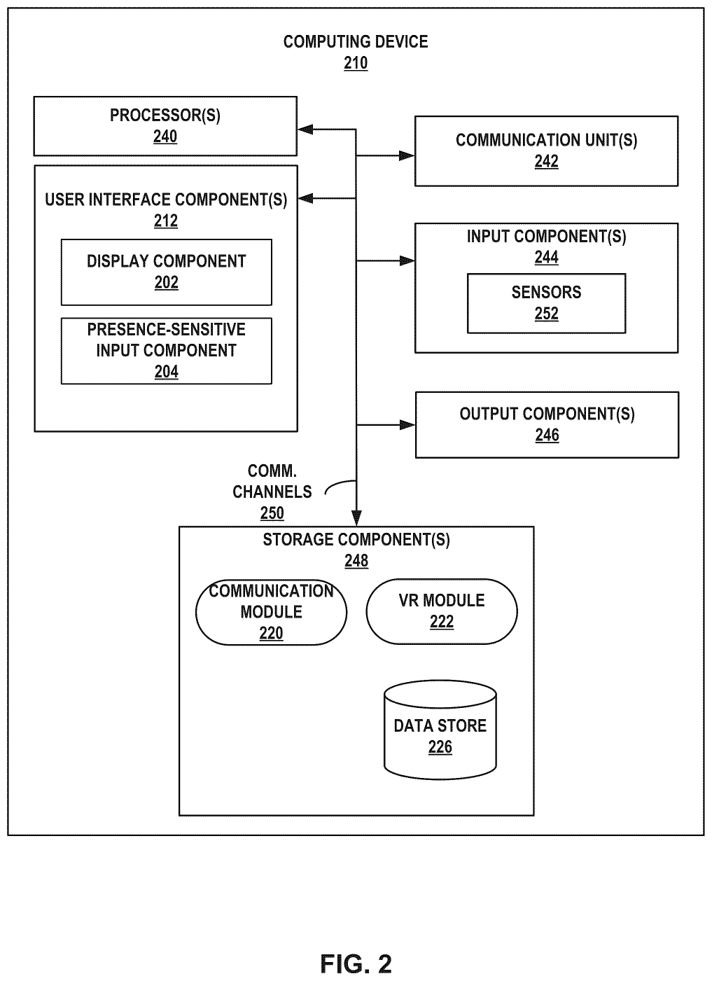

FIG. 2 is a block diagram illustrating an example computing device configured to determine a characteristic of received user input and output a corresponding set of sub-elements associated with an application on the computing device, in accordance with one or more aspects of the techniques described in this disclosure. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. For instance, computing device 210 may be a VR system itself. In other instances, computing device 210 is a separate computing device that outputs a virtual reality environment to a virtual reality display.

As shown in the example of FIG. 2, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, VR module 222, and data store 226.

One or more processors 240 may implement functionality and/or execute instructions associated with computing device 210 to create a virtual reality environment. That is, processors 240 may implement functionality and/or execute instructions associated with computing device 210 to develop a virtual reality environment with various educational modules.

Examples of processors 240 include application processors, display controllers, auxiliary processors, one or more sensor hubs, and any other hardware configure to function as a processor, a processing unit, or a processing device. Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to create and interact with a virtual reality environment.

Communication module 220 may execute locally (e.g., at processors 240) to provide functions associated with communicating with cameras (such as sensors 252 when the cameras are implemented in computing device 210, or with one or more external cameras (not pictured)) and virtual reality output devices. In some examples, communication module 220 may act as an interface to a remote service accessible to computing device 210. For example, communication module 220 may be an interface or application programming interface (API) to a remote server.

In some examples, VR module 222 may execute locally (e.g., at processors 240) to provide functions associated with creating and interacting with a virtual reality environment. In some examples, VR module 222 may act as an interface to a remote service accessible to computing device 210. For example, VR module 222 may be an interface or application programming interface (API) to a remote server that analyzes indications of user input and creates or adjusts a virtual reality environment.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, computing device 210 may perform any of the methods or techniques described herein, including controlling any sensors or cameras, analyzing any data, creating any virtual reality environments, analyzing any user input, and outputting any interactive virtual reality environment described throughout this disclosure, the examples, and the claims. For instance, communication module 220 may capture, using one or more cameras, one or more 360-degree images of a medical environment, wherein each of the one or more 360-degree images are captured with one of the one or more cameras being placed at a respective location.

In some instances, the medical environment may be a room or space in a hospital, medical facility, or treatment facility. For example, the medical environment may be any one or more of an operating room, an emergency room, a clinical room, a scrubbing room, a treatment room, and a nursing station.

In some instances, each of the one or more 360-degree images may be any one or more of static images and videos.

VR module 222 may create a virtual reality environment of the medical environment based on the one or more 360-degree images of the medical environment. In creating the virtual reality environment comprises, for each of the one or more 360-degree images, VR module 222 may place a user viewpoint at the respective location of the respective camera of the one or more cameras that captured the respective 360-degree image. VR module 222 may place a graphical representation of a first class at each other respective location that is visible in the respective 360-degree image. For instance, the first class of graphical representations may be depicted as graphical discs. VR module 222 may also place a graphical representation of a second class over each object visible in the respective 360-degree image that has particular educational content assigned to the object. For instance, the second class of graphical representations may be depicted as graphical starbursts. The educational content may include any one or more of a video, an image, textual content, and audio.

Communication module 220 may output, for interactive display at a virtual reality device, the virtual reality environment.

In some examples, the one or more 360-degree images may include a plurality of 360-degree images. In such examples, while communication module 220 outputs the virtual reality environment, VR module 222 may place a current viewpoint at the user viewpoint of a first 360-degree image of the plurality of 360-degree images. Communication module 220 may receive an indication of user input selecting a graphical representation visible from the current viewpoint within the virtual reality environment, wherein the graphical representation belongs to the first class of graphical representation. In response to receiving the indication of user input, VR module 222 may update the current viewpoint to be the user viewpoint for a second 360-degree image of the plurality of 360-degree images. Communication module 220 may output, for interactive display at the virtual reality device, the virtual reality environment as depicted from the user viewpoint for the second 360-degree image.

Additionally or alternatively, communication module 220 may receive an indication of user input selecting a graphical representation visible from the current viewpoint within the virtual reality environment, wherein the graphical representation belongs to the second class of graphical representation. In response to receiving the indication of user input, VR module 222 may update the virtual reality environment to include at least a portion of the particular educational content assigned to the selected graphical representation. Communication module 220 may output the virtual reality environment with at least the portion of the particular educational content assigned to the selected graphical representation.

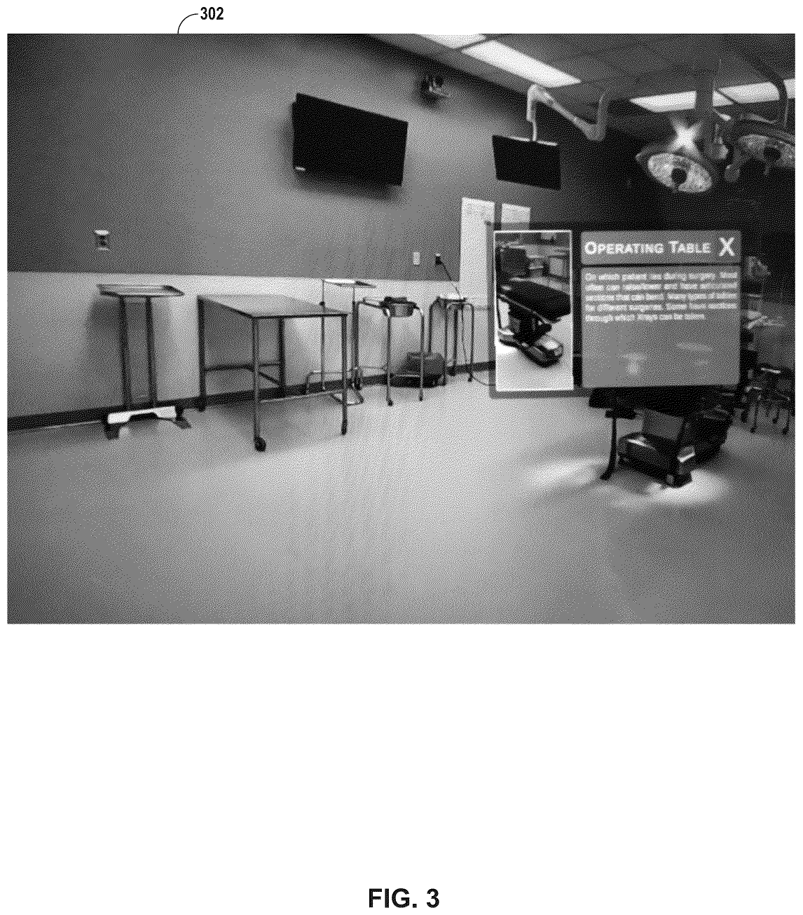

FIG. 3 is an example virtual reality environment, in accordance with the techniques of this disclosure. The example of FIG. 3 includes expanding on a piece of equipment in the OR, in this case the Operating Table. The description is given. The photo of the equipment can be enlarged. From this virtual reality environment, a user may provide user selections into the virtual reality system to access educational content regarding the operating table, such as textual descriptions of the style or components of the table, a video demonstrating how to place a patient onto the table, images of the operating table in use, or any other visible or audible content that would train a user to better understand and utilize the operating table.

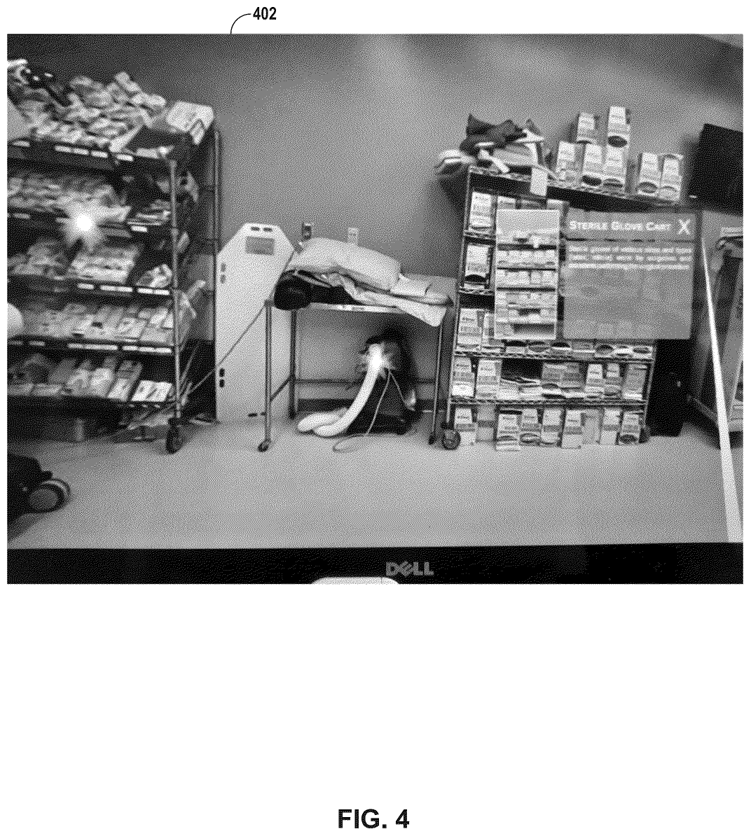

FIG. 4 is an example virtual reality environment, in accordance with the techniques of this disclosure. The example of FIG. 4 includes expanding on a piece of equipment in the OR, in this case the Sterile Glove Cart. The description is given. The photo of the cart can be enlarged. From this virtual reality environment, a user may provide user selections into the virtual reality system to access educational content regarding the sterile glove cart, such as textual descriptions of the contents of the cart, a video demonstrating how to lock the wheels of the cart into place or to unlock the wheels of the cart to allow for movement of the cart, an audible presentation describing the importance of sterile equipment, or any other visible or audible content that would train a user to better understand and utilize the sterile glove cart or its contents.

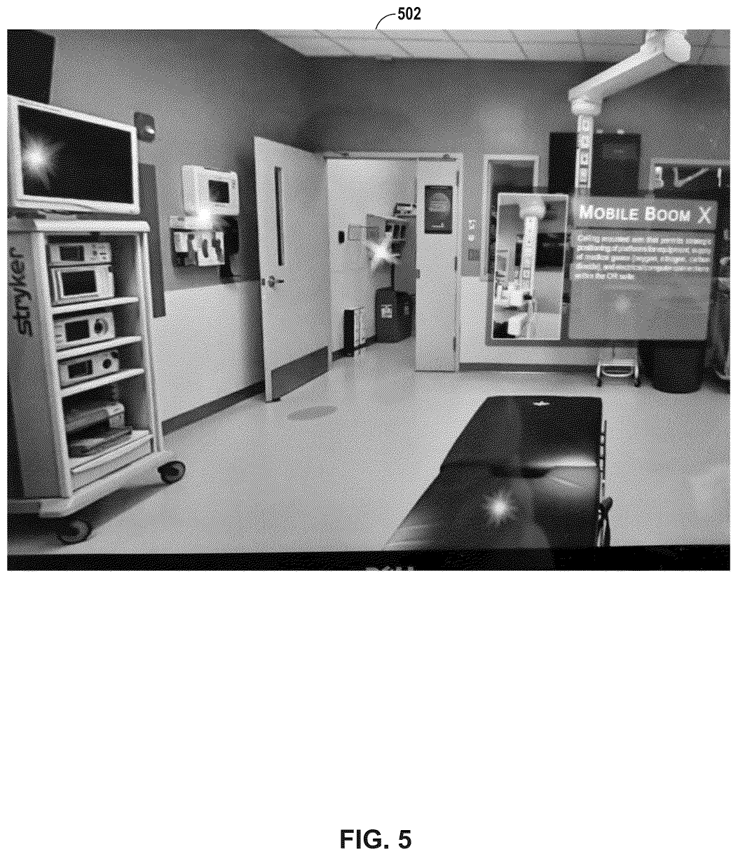

FIG. 5 is an example virtual reality environment 502, in accordance with the techniques of this disclosure. The example of FIG. 5, virtual reality environment 502 includes expanding information on a piece of equipment in the OR, in this case the Mobile Boom. The description is given. The photo of the boom, and its connections on the vertical arm, can be enlarged. From this virtual reality environment 502, a user may provide user selections into the virtual reality system to access educational content regarding the mobile boom, such as textual descriptions of the procedures and circumstances where the mobile boom should be used, a video demonstrating how to use the mobile boom in a procedure, images of different states of the mobile boom, or any other visible or audible content that would train a user to better understand and utilize the mobile boom or its associated procedures.

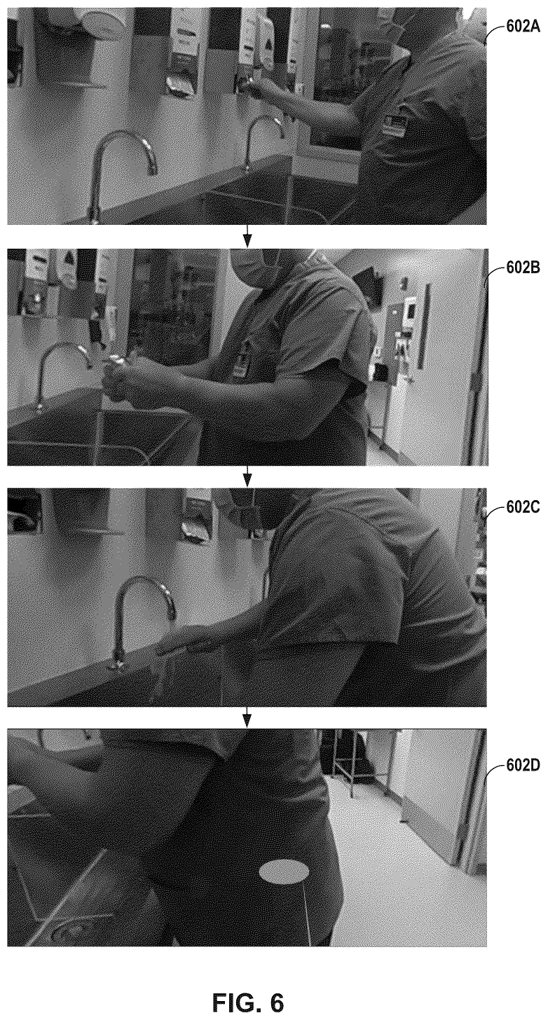

FIG. 6 is an example virtual reality environment as a video, in accordance with the techniques of this disclosure. In the example of FIG. 6, the virtual reality environment 602A is the beginning frame of a video showing a doctor scrubbing before a surgical procedure. Virtual reality environment 602B is a second (though not necessarily consecutive) frame, virtual reality environment 602C is a third (though not necessarily consecutive) frame, and virtual reality environment 602D is a fourth (though not necessarily consecutive) frame. As it is a virtual reality environment, the user may still look around in a 360-degree view while the video within the virtual reality environment plays in the background, providing the user with an immersive experience with both static and moving virtual reality environments. Additionally, audio may be played describing what the doctor is doing at various times of the video and highlighting the importance of cleanliness and handwashing in medical situations.

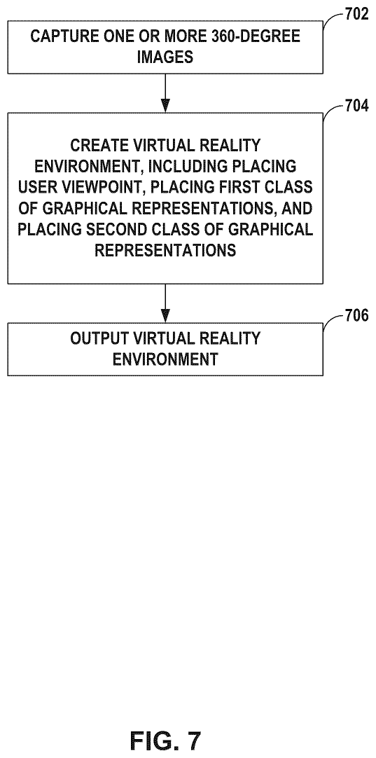

FIG. 7 is a flow diagram illustrating an example method for creating a virtual reality environment, in accordance with the techniques of this disclosure. The techniques of FIG. 7 may be performed by one or more processors of a computing device, such as system 100 of FIG. 1 and/or computing device 210 illustrated in FIG. 2. For purposes of illustration only, the techniques of FIG. 6 are described within the context of computing device 210 of FIG. 2, although computing devices having configurations different than that of computing device 210 may perform the techniques of FIG. 6.

In accordance with the techniques of this disclosure, one or more cameras, which may under control of communication module 220, may capture one or more 360-degree images of a medical environment (702). Each of the one or more 360-degree images are captured with one of the one or more cameras being placed at a respective location. VR module 220 may create a virtual reality environment of the operating room environment based on the one or more 360-degree images of the medical environment, by for each of the one or more 360-degree images, placing a user viewpoint at the respective location of the respective camera of the one or more cameras that captured the respective 360-degree image, placing a graphical representation of a first class at each other respective location that is visible in the respective 360-degree image, and placing a graphical representation of a second class over each object visible in the respective 360-degree image that has particular educational content assigned to the object (704). Communication module 220 may output, for interactive display at a virtual reality device, the virtual reality environment (706).

Example 1. A method comprising: (a) capturing, by one or more cameras, one or more 360-degree images of a medical environment, wherein each of the one or more 360-degree images are captured with one of the one or more cameras being placed at a respective location; (b) creating, by one or more processors, a virtual reality environment of the medical environment based on the one or more 360-degree images of the medical environment, wherein creating the virtual reality environment comprises, for each of the one or more 360-degree images: (i) placing a user viewpoint at the respective location of the respective camera of the one or more cameras that captured the respective 360-degree image; (ii) placing a graphical representation of a first class at each other respective location that is visible in the respective 360-degree image; and (iii) placing a graphical representation of a second class over each object visible in the respective 360-degree image that has particular educational content assigned to the object; and (c) outputting, by the one or more processors and for interactive display at a virtual reality device, the virtual reality environment.

Example 2. The method of example 1, wherein the one or more 360-degree images comprises a plurality of 360-degree images.

Example 3. The method of example 2, further comprising: (a) while outputting the virtual reality environment, placing, by the one or more processors, a current viewpoint at the user viewpoint of a first 360-degree image of the plurality of 360-degree images.

Example 4. The method of example 3, further comprising: (a) receiving, by the one or more processors, an indication of user input selecting a graphical representation visible from the current viewpoint within the virtual reality environment, wherein the graphical representation belongs to the first class of graphical representation; and (b) in response to receiving the indication of user input: (i) updating, by the one or more processors, the current viewpoint to be the user viewpoint for a second 360-degree image of the plurality of 360-degree images; and (ii) outputting, by the one or more processors and for interactive display at the virtual reality device, the virtual reality environment as depicted from the user viewpoint for the second 360-degree image.

Example 5. The method of any one or more of examples 3-4, further comprising: (a) receiving, by the one or more processors, an indication of user input selecting a graphical representation visible from the current viewpoint within the virtual reality environment, wherein the graphical representation belongs to the second class of graphical representation; and (b) in response to receiving the indication of user input: (i) updating, by the one or more processors, the virtual reality environment to include at least a portion of the particular educational content assigned to the selected graphical representation; and (ii) outputting, by the one or more processors, the virtual reality environment with at least the portion of the particular educational content assigned to the selected graphical representation.

Example 6. The method of any one or more of examples 1-5, wherein the educational content comprises one or more of: (i) a video; (ii) an image; (iii) textual content; and (iv) audio.

Example 7. The method of any one or more of examples 1-6, wherein the first class of graphical representations are depicted as graphical discs.

Example 8. The method of any one or more of examples 1-7, wherein the second class of graphical representations are depicted as graphical starbursts.

Example 9. The method of any one or more of examples 1-8, wherein the medical environment is a room or space in a hospital, medical facility, or treatment facility.

Example 10. The method of any one or more of examples 1-9, wherein the medical environment comprises one or more of: (i) an operating room; (ii) an emergency room; (iii) a clinical room; (iv) a scrubbing room; (v) a treatment room; (vi) a nursing station; (vii) a trauma unit; and (vii) an endoscopy unit.

Example 11. The method of any one or more of examples 1-10, wherein each of the one or more 360-degree images comprise one or more of: (i) static images; and (ii) videos.

Example 12. A method for performing any of the techniques of any combination of examples 1-11.

Example 13. A device configured to perform any of the methods of any combination of examples 1-11.

Example 14. An apparatus comprising means for performing any of the method of any combination of examples 1-11.

Example 15. A non-transitory computer-readable storage medium having stored thereon instructions that, when executed, cause one or more processors of a computing device to perform the method of any combination of examples 1-11.

Example 16. A system comprising one or more computing devices configured to perform a method of any combination of examples 1-11.

Example 17. Any of the techniques described herein.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4 This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

What is claimed is:

1. A method comprising:
(a) capturing, by one or more cameras, one or more 360-degree images of a medical environment, wherein each of the one or more 360-degree images are captured with one of the one or more cameras being placed at a respective location;
(b) creating, by one or more processors, a virtual reality environment of the medical environment based on the one or more 360-degree images of the medical environment, wherein creating the virtual reality environment comprises, for each of the one or more 360-degree images:
(i) placing a user viewpoint at the respective location of the respective camera of the one or more cameras that captured the respective 360-degree image;
(ii) placing a graphical representation of a first class at each other respective location that is visible in the respective 360-degree image; and
(iii) placing a graphical representation of a second class over each object visible in the respective 360-degree image that has particular educational content assigned to the object; and
(c) outputting, by the one or more processors and for interactive display at a virtual reality device, the virtual reality environment.

2. The method of claim 1, wherein the one or more 360-degree images comprises a plurality of 360-degree images.

3. The method of claim 2, further comprising:
(a) while outputting the virtual reality environment, placing, by the one or more processors, a current viewpoint at the user viewpoint of a first 360-degree image of the plurality of 360-degree images.

4. The method of claim 3, further comprising:
(a) receiving, by the one or more processors, an indication of user input selecting a graphical representation visible from the current viewpoint within the virtual reality environment, wherein the graphical representation belongs to the first class of graphical representation; and
(b) in response to receiving the indication of user input:
(i) updating, by the one or more processors, the current viewpoint to be the user viewpoint for a second 360-degree image of the plurality of 360-degree images; and
(ii) outputting, by the one or more processors and for interactive display at the virtual reality device, the virtual reality environment as depicted from the user viewpoint for the second 360-degree image.

5. The method of claim 3, further comprising:
(a) receiving, by the one or more processors, an indication of user input selecting a graphical representation visible from the current viewpoint within the virtual reality environment, wherein the graphical representation belongs to the second class of graphical representation; and
(b) in response to receiving the indication of user input:
(i) updating, by the one or more processors, the virtual reality environment to include at least a portion of the particular educational content assigned to the selected graphical representation; and
(ii) outputting, by the one or more processors, the virtual reality environment with at least the portion of the particular educational content assigned to the selected graphical representation.

6. The method of claim 1, wherein the educational content comprises one or more of:
(i) a video;
(ii) an image;
(iii) textual content; and
(iv) audio.

7. The method of claim 1, wherein the first class of graphical representations are depicted as graphical discs.

8. The method of claim 1, wherein the second class of graphical representations are depicted as graphical starbursts.

9. The method of claim 1, wherein the medical environment is a room or space in a hospital, medical facility, or treatment facility.

10. The method of claim 1, wherein the medical environment comprises one or more of:
(i) an operating room;
(ii) an emergency room;
(iii) a clinical room;
(iv) a scrubbing room;
(v) a treatment room;
(vi) a nursing station;
(vii) a trauma unit; and
(vii) an endoscopy unit.

11. The method of claim 1, wherein each of the one or more 360-degree images comprise one or more of:
(i) static images; and
(ii) videos.

12. A computing device comprising one or more processors configured to:
(a) control one or more cameras to one or more 360-degree images of a medical environment, wherein each of the one or more 360-degree images are captured with one of the one or more cameras being placed at a respective location;
(b) create a virtual reality environment of the medical environment based on the one or more 360-degree images of the medical environment, wherein creating the virtual reality environment comprises, for each of the one or more 360-degree images:
(i) place a user viewpoint at the respective location of the respective camera of the one or more cameras that captured the respective 360-degree image;
(ii) place a graphical representation of a first class at each other respective location that is visible in the respective 360-degree image; and
(iii) place a graphical representation of a second class over each object visible in the respective 360-degree image that has particular educational content assigned to the object; and
(c) output, for interactive display at a virtual reality device, the virtual reality environment.

13. The computing device of claim 12, wherein the one or more 360-degree images comprises a plurality of 360-degree images.

14. The computing device of claim 13, wherein the one or more processors are further configured to:
(a) while outputting the virtual reality environment, place a current viewpoint at the user viewpoint of a first 360-degree image of the plurality of 360-degree images.

15. The computing device of claim 14, wherein the one or more processors are further configured to:
(a) receive an indication of user input selecting a graphical representation visible from the current viewpoint within the virtual reality environment, wherein the graphical representation belongs to the first class of graphical representation; and
(b) in response to receiving the indication of user input:
(i) update the current viewpoint to be the user viewpoint for a second 360-degree image of the plurality of 360-degree images; and
(ii) output, for interactive display at the virtual reality device, the virtual reality environment as depicted from the user viewpoint for the second 360-degree image.

16. The computing device of claim 14, wherein the one or more processors are further configured to:
(a) receive an indication of user input selecting a graphical representation visible from the current viewpoint within the virtual reality environment, wherein the graphical representation belongs to the second class of graphical representation; and
(b) in response to receiving the indication of user input:
(i) update the virtual reality environment to include at least a portion of the particular educational content assigned to the selected graphical representation; and
(ii) output the virtual reality environment with at least the portion of the particular educational content assigned to the selected graphical representation.

17. A non-transitory computer-readable storage medium having stored thereon instructions that, when executed, cause one or more processors of a computing device to:
(a) control one or more cameras to one or more 360-degree images of a medical environment, wherein each of the one or more 360-degree images are captured with one of the one or more cameras being placed at a respective location;
(b) create a virtual reality environment of the medical environment based on the one or more 360-degree images of the medical environment, wherein creating the virtual reality environment comprises, for each of the one or more 360-degree images:
(i) place a user viewpoint at the respective location of the respective camera of the one or more cameras that captured the respective 360-degree image;
(ii) place a graphical representation of a first class at each other respective location that is visible in the respective 360-degree image; and
(iii) place a graphical representation of a second class over each object visible in the respective 360-degree image that has particular educational content assigned to the object; and
(c) output, for interactive display at a virtual reality device, the virtual reality environment.

18. The non-transitory computer-readable storage medium of claim 17, wherein the one or more 360-degree images comprises a plurality of 360-degree images.

19. The non-transitory computer-readable storage medium of claim 18, wherein the instructions, when executed, further cause the one or more processors to:
(a) while outputting the virtual reality environment, place a current viewpoint at the user viewpoint of a first 360-degree image of the plurality of 360-degree images.

20. The non-transitory computer-readable storage medium of claim 19, wherein the instructions, when executed, further cause the one or more processors to:
(a) receive an indication of user input selecting a graphical representation visible from the current viewpoint within the virtual reality environment, wherein the graphical representation belongs to the second class of graphical representation; and
(b) in response to receiving the indication of user input:
(i) update the virtual reality environment to include at least a portion of the particular educational content assigned to the selected graphical representation; and
(ii) output the virtual reality environment with at least the portion of the particular educational content assigned to the selected graphical representation.
